(19) United States
(12) Patent Application Publication
(10) Pub. No.: US 2006/0190669 A1
(43) Pub. Date: Aug. 24, 2006

(54) Wireless hard disk drive

(75) Inventors: Sung Jin Lee, Incheon (KR); Keven Hoon Kim, La Habra, CA (US)

Correspondence Address: STAAS & HALSEY LLP, SUITE 700, 1201 NEW YORK AVENUE, N.W., WASHINGTON, DC, 20005, US

(73) Assignees: Sung Jin LEE, Incheon-shi (KR); Keven Hoon KIM of California, USA

(21) Appl. No.: 11/108,685

(22) Filed: Apr. 19, 2005

(30) Foreign Application Priority Data
Feb. 16, 2005 (KR) 10-2005-0012813

(51) Int. Cl. G06F 3/06; G06F 12/00

(52) U.S. Cl. 711/4

(57) ABSTRACT

A wireless hard disk drive is disclosed. The wireless hard disk drive includes a microprocessor, a Synchronous Dynamic Random Access Memory (SDRAM), a hard disk, a wireless chip, an antenna, and an Ethernet communication unit. The microprocessor has an SDRAM controller, a wireless chip controller and an Ethernet controller. The SDRAM is interfaced with the SDRAM controller of the microprocessor, and stores operational data. The hard disk is interfaced with a memory controller of the microprocessor, and stores data. The wireless chip is interfaced with the wireless chip controller of the microprocessor, and is configured to modulate data into radio frequency signals and then transmit the radio frequency signals, and to demodulate received radio frequency signals into data and then transfer the data. The antenna is connected to a transmitter and a receiver. The Ethernet communication unit is interfaced with the Ethernet controller, and allows the data to be stored and the data stored on the hard disk to be accessed. The elements are contained in a single portable housing, so that the wireless hard disk drive can have mobility, portability and wireless connectivity to a host device.

### BACKGROUND OF THE INVENTION

1. Field of the Invention

The present invention relates generally to a hard disk drive and, more particularly, to a hard disk drive, in which a hard disk capable of recording a large volume of data in a magnetic information form is provided, and which allows a host device, such as a notebook computer, a personal computer, a personal computer server computer, a personal digital assistant or an MP3 player, to wirelessly access the hard disk and store data on or read data from the hard disk.

2. Description of the Related Art

A conventional hard disk drive is provided inside the housing of a host device, or is wired to the host device for use after manufactured as an external drive that is separate from the host device.

However, the hard disk contained in the host device is problematic in that it has limited spatial mobility. In particular, this limitation inconveniences current users who want to store a large number of multimedia files on a hard disk and to use the hard disk while moving from one location to another or changing from one host device to another.

To solve the problem of the spatial immobility of the hard disk, the external hard disk has been developed. However, the external hard disk is inconvenient in that the user using the hard disk must connect and disconnect a data cable when changing from one host device to another or moving from one location to another. Particularly, in the case in which the host device is a portable device, such as a Portable Media Player (PMP), an MP3 Player, a digital camera or a mobile phone handset, great inconvenience occurs when the user uses the external hard disk because the user must connect and disconnect the data cable between the host device and the external hard disk and must not disconnect the data cable during the use of the external hard disk.

Recently, as wireless Local Area Networks (LANs) and the wireless Internet have been popularized, many users add wireless LANs to their own host devices, or purchase host devices equipped with wireless LANs. Most Wireless LANS currently popularized are products that follow the IEEE 802.11 specifications family that define wireless communication protocols between a base station and a client or between clients. The IEEE 802.11 specifications family includes the IEEE 802.11 specification, the IEEE 802.11a specification, the IEEE 802.11b specification and the IEEE 802.11g specification, but the most widely used one of these specifications is the 802.11b specification.

### SUMMARY OF THE INVENTION

Accordingly, the present invention has been made keeping in mind the above problems occurring in the prior art, and an object of the present invention is to provide a wireless hard disk drive which realizes wireless connectivity with a host device as well as spatial mobility and maximize convenience of the use of an external hard disk.

In order to accomplish the above object, the present invention provides a wireless hard disk drive, including a microprocessor configured to have a Synchronous Dynamic Random Access Memory (SDRAM) controller, a wireless chip controller and an Ethernet controller; an SDRAM interfaced with an SDRAM controller of the microprocessor, and configured to store operational data of the microprocessor; a hard disk interfaced with a memory controller of the microprocessor, and configured to store data; a wireless chip interfaced with a wireless chip controller of the microprocessor, and configured to modulate data, which are stored on the hard disk, into radio frequency signals and then transmit the radio frequency signals, and to demodulate received radio frequency signals into data and then transfer the data to the wireless chip of the wireless chip controller; an antenna connected to a transmitter and receiver, and configured to transmit radio frequency signals to the air and detect the radio frequency signals from the air; and an Ethernet communication unit interfaced with the Ethernet controller, and configured to allow the data to be stored on the hard disk and allow the data stored on the hard disk to be accessed via a network; wherein the elements are contained in a single portable housing, so that the wireless hard disk drive can have mobility, portability and wireless connectivity to a host device.

Preferably, the microprocessor further includes a memory controller, and the memory controller of the microprocessor is interfaced with one or more of Synchronous Random Access Memory (SRAM), flash memory and Read-Only Memory (ROM).

Preferably, the microprocessor further includes a serial port, so that the microprocessor can be connected to a serial communication device.

Preferably, the microprocessor further includes a Universal Serial Bus (USB) port, so that the microprocessor can be connected to a USB communication device.

Preferably, the hard disk is one of 2.5 and 1.8-inch disks.

Preferably, the housing contains a battery that is capable of supplying power to the elements.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a wireless hard disk drive according to the present invention;

FIG. 2 is an exploded perspective view showing a wireless hard disk according to a preferred embodiment of the present invention; and

FIG. 3 is a view showing the use of the wireless hard disk shown in FIG. 2.

### DESCRIPTION OF THE PREFERRED EMBODIMENTS

A preferred embodiment of the present invention is described in detail with reference to the accompanying drawings below.

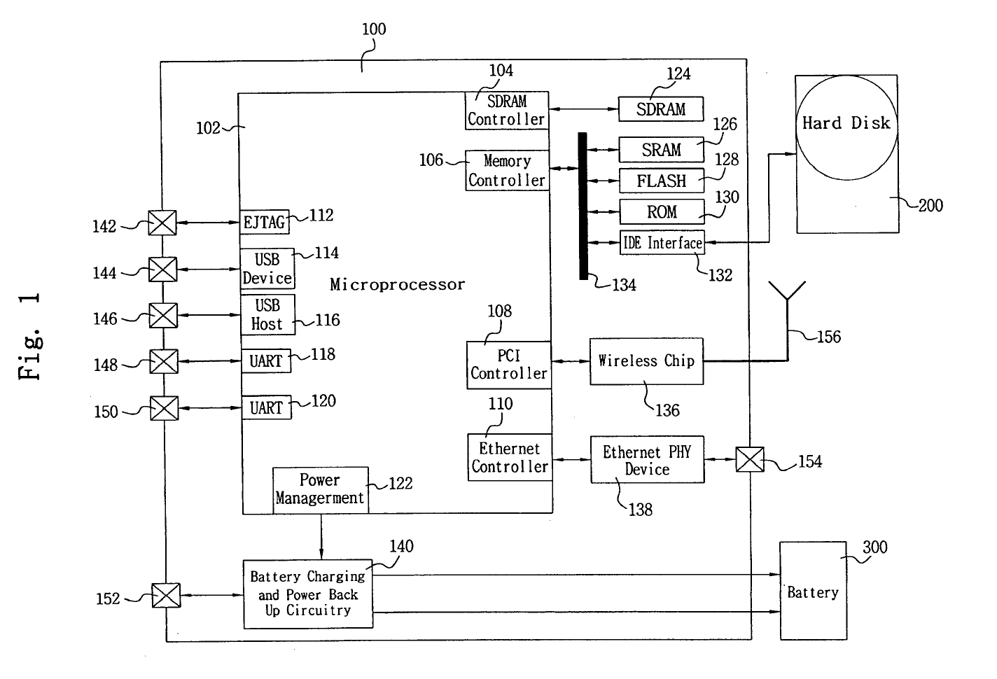

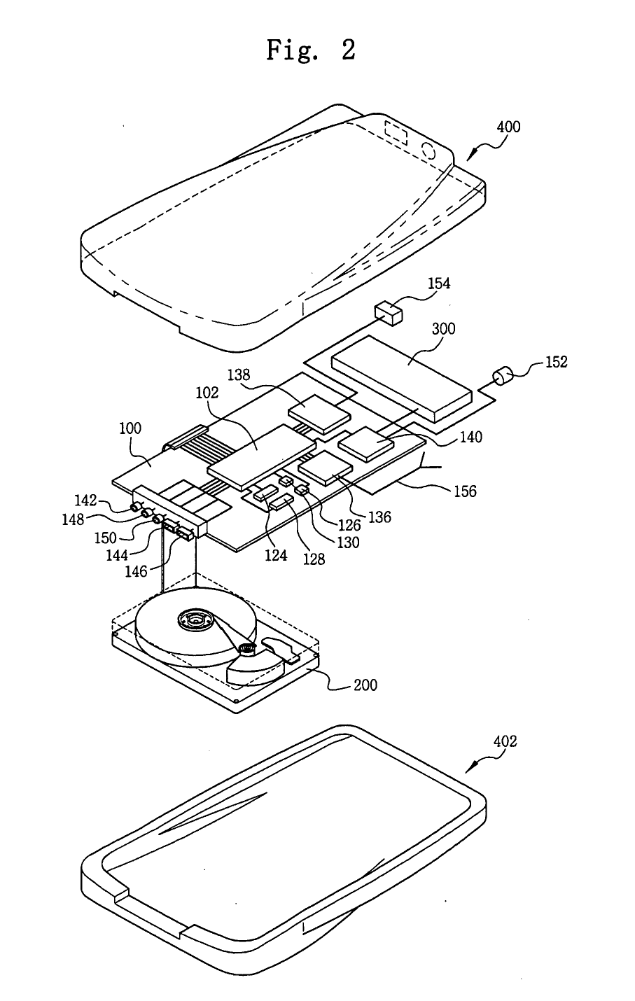

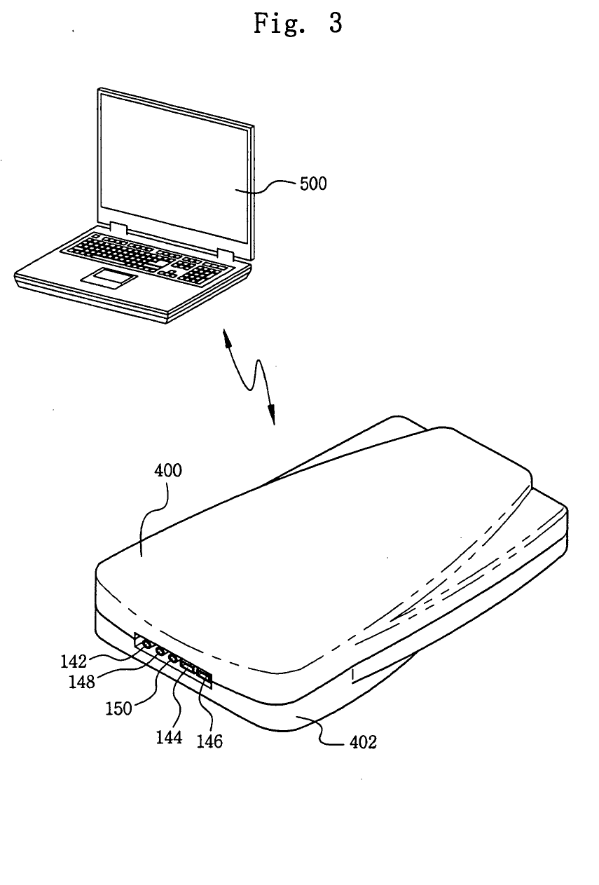

FIG. 1 is a block diagram showing a wireless hard disk drive according to the present invention, FIG. 2 is an exploded perspective view showing a wireless hard disk according to the preferred embodiment of the present invention, and FIG. 3 is a view showing the use of the wireless hard disk shown in FIG. 2.

Referring to FIG. 1, the wireless hard disk drive according to the present invention is characterized in that it controls both a hard disk 200 and a wireless chip 136 using a single microprocessor 102, so that data stored on the hard disk 200 can be wirelessly transmitted to a host device and data wirelessly received from a host device can be stored on the hard disk 200. In this case, the host device includes all the devices, such as a Personal Computer (PC), a PC server computer, a Personal Digital Assistant (PDA), a MP3 player, a mobile phone, a PMP, a notebook computer or a digital camera, that can use an auxiliary storage device to store data.

Preferably, a low power System On Chip (SOC) processor is used as the microprocessor 102. The SOC processor must be fit to implement a portable wireless hard disk drive by including memory controllers 104 and 106, a Peripheral Component Interface (PCI) controller 108 and an Ethernet controller 110 as well as a Central Processing Unit (CPU) in a single chip. Furthermore, since the wireless hard disk drive according to the present invention is manufactured such that it is compatible with various host devices, it is required that the microprocessor 102 must support various Operating System (OS), such as Window CE .NET, Linux and VxWorks.

The microprocessor 102 is connected to the wireless chip 136 that modulates data stored on the hard disk 200 into radio frequency signals and then transmits the modulated radio frequency signals to a host device, or that demodulates radio frequency signals received from the host devices into data and then transmits the demodulated data to the microprocessor 102.

Although it is preferred that the wireless chip 136 be implemented using a chip adopting the IEEE 802.11b protocol, the wireless chip 136 is not limited only to the chip adopting the IEEE 802.11b protocol. Furthermore, a chip adopting IEEE 802.11g, or any other chips that can replace the wireless chip 136, may be used. A representative wireless chip adopting the IEEE 802.11b protocol is an Am1772 wireless chip manufactured by Advanced Micro Devices (AMD) Inc. Similarly, a representative wireless chip adopting IEEE 802.11g is a Cx85510 wireless chip manufactured by Advanced Micro Devices (AMD) Inc. Although a single wireless chip 136 is illustrated in FIG. 1, two wireless chips may be installed in parallel to increase compatibility with host devices. For example, both the Am1772 and Cx85510 wireless chips may be used. The wireless chip 136 may be interfaced with the PCI controller 108 of the microprocessor 102. That is, the PCI controller 108 of the microprocessor 102 may be used as a wireless chip controller. An antenna 156 that is an internal mount type antenna or an external mount type antenna is connected to the transmitter and receiver of the wireless chip 136, and is configured to transmit data to the host device by radiating radio frequency signals to the air and to detect radio frequency signals and transfer the radio frequency signals received from the host devices to the transmitter and receiver of the wireless chip 136. The hard disk 200 is connected to the memory controller 106 of the microprocessor 200 via an Integrated Drive Electronics (IDE) interface. Preferably, the hard disk 200 is either 2.5 or 1.8-inch disk to improve the portability and mobility thereof.

The microprocessor 102 shown in FIG. 1 has two memory controllers. One is an SDRAM controller 104 that is used to control an SDRAM 124 that stores data required when the microprocessor 102 executes a program, and the other is a memory controller 106 that is used to control static memory devices, that is, SRAM 126, flash memory and ROM 130. These static memory devices are used to store booting code and the image files of application programs, or are used as auxiliary storage devices for other purposes. The booting code is executed by the microprocessor 102 after being copied to the SDRAM.

Referring to FIG. 1 again, Ethernet is used as the wired interface of the wireless hard disk drive according to the present invention. For this purpose, the microprocessor 102 includes an Ethernet controller 110, and connects programs, which are executed in an Ethernet communication device, that is, an Ethernet Physical Layer Device (EPLD), and the microprocessor 102, via a Media Independent Interface (MII). The present invention may use an USB as a wired interface. The microprocessor 102 preferably includes a USB host controller 116 and a USB device controller 114 so that USB communication devices can be further connected.

The microprocessor 102 may further include serial communication controllers 118 and 120 to be connected with serial communication peripheral devices, such as a Blue Tooth device.

In FIG. 1, an Emulation Joint Test Access Group (EJTAG) controller 112 is used to load a boot loader on the microprocessor 102 or board 100 and debug the boot loader. Furthermore, reference numerals 142 to 154 designate connectors.

Although Direct Current (DC) power obtained by rectifying and converting commercial power using an adaptor may be used as power for the elements of the present invention described above, it is preferred that the present invention further includes a battery 300 and a battery charging and power backup circuit 140, so that the hard disk drive of the present invention can be easily used as the storage device of a portable information device.

Referring to FIG. 2, the elements of the present invention described above are contained in a single portable housing, so that the hard disk drive of the present invention can have portability, mobility and, wireless connectivity with host devices. FIG. 2 illustrates an example of the case in which the microprocessor 102, all the memory devices 124, 126, 128 and 130, the wireless chip 136, the antenna 156, the Ethernet communication device 138, and the connectors 142 to 154 are mounted on a single board 100. In this case, it is not necessary to mount all the elements on a single board, and the arrangement of the element can be changed without limitation. Furthermore, although FIG. 2 illustrates the wireless hard disk drive with the upper cover of the hard disk 200 being removed, the hard disk 200 is covered with the upper cover when the hard disk 200 is mounted in the hard disk drive. Although a hard disk controller for controlling the hard disk 200 is not shown, the hard disk controller is provided on the lower cover of the hard disk 200.

As shown in FIG. 3, the wireless hard disk drive according to the present invention can be carried by users, and can store and reproduce data while exchanging the data with a host device, such as PC, a PC server computer, a PDA, an MP3 player, a mobile phone, a PMP, a notebook computer or a digital camera regardless of a location.

As described above, since the hard disk drive of the present invention allows a large volume of data, which a user selects, stores and edits, to be moved and used without limitations regarding the location and the host device, ease of the use of the hard disk increases. In particular, the usefulness of portable information devices is maximized when the wireless hard disk drive is used as the storage device of the portable information device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wireless hard disk drive, comprising:
a microprocessor configured to have a Synchronous Dynamic Random Access Memory (SDRAM) controller, a wireless chip controller and an Ethernet controller;
an SDRAM interfaced with an SDRAM controller of the microprocessor, and configured to store operational data of the microprocessor;
a hard disk interfaced with a memory controller of the microprocessor, and configured to store data;
a wireless chip interfaced with a wireless chip controller of the microprocessor, and configured to modulate data, which are stored on the hard disk, into radio frequency signals and then transmit the radio frequency signals, and to demodulate received radio frequency signals into data and then transfer the data to the wireless chip of the wireless chip controller;
an antenna connected to a transmitter and receiver, and configured to transmit radio frequency signals to the air and detect the radio frequency signals from the air; and
an Ethernet communication unit interfaced with the Ethernet controller, and configured to allow the data to be stored on the hard disk and allow the data stored on the hard disk to be accessed via a network;
wherein the elements are contained in a single portable housing, so that the wireless hard disk drive can have mobility, portability and wireless connectivity to a host device.

2. The wireless hard disk drive as set forth in claim 1, wherein the microprocessor further comprises a memory controller, and the memory controller of the microprocessor is interfaced with one or more of Synchronous Random Access Memory (SRAM), flash memory and Read-Only Memory (ROM).

3. The wireless hard disk drive as set forth in claim 1, wherein the microprocessor further comprises a serial port, so that the microprocessor can be connected to a serial communication device.

4. The wireless hard disk drive as set forth in claim 1, wherein the microprocessor further comprises a Universal Serial Bus (USB) port, so that the microprocessor can be connected to a USB communication device.

5. The wireless hard disk drive as set forth in claim 1, wherein the hard disk is one of 2.5 and 1.8-inch disks.

6. The wireless hard disk drive as set forth in any one of claims 1 to 5, wherein the housing contains a battery that is capable of supplying power to the elements.
